(19) United States
(12) Patent Application Publication
(10) Pub. No.: US 2024/0390792 A1
(43) Pub. Date: Nov. 28, 2024

(54) Consumer Device with Dual Wireless Links and Mixer

(71) Applicant: Sony Interactive Entertainment Inc., Tokyo (JP)

(72) Inventor: Edwin Foo, San Mateo, CA (US)

(21) Appl. No.: 18/633,353

(22) Filed: Apr. 11, 2024

Related U.S. Application Data
(60) Provisional application No. 63/504,030, filed on May 24, 2023.

(51) Int. Cl. A63F 13/54; H04R 1/10

(52) U.S. Cl. CPC A63F 13/54; H04R 1/1041; H04R 1/1008; H04R 1/1016; H04R 2420/07

(57) ABSTRACT

A listening device such as earbuds or headphones may include two different wireless receivers, one for receiving, for example, Bluetooth carrying audio from a smart phone and the other for receiving non-Bluetooth signals. A mixer in the listening device mixes the two audio streams received via the two receivers and plays the resulting mixed audio on the left and right speakers of the listening device.

### FIELD

The disclosure below relates generally to consumer devices such as earphones or earbuds with dual wireless links and mixers.

### BACKGROUND

As recognized herein, people listening to computer simulations such as computer games may wish to listen to two sources of sound at once in their headphones or earbuds. For example, they may wish to hear game audio along with a third party service that sources music or chat-like audio.

### SUMMARY

Accordingly, in one aspect a head-wearable listening device includes a left speaker assembly configured to engage a left ear and a right speaker assembly configured to engage a right ear. The device includes a first wireless receiver configured to operate at a first frequency and/or first protocol and a second wireless receiver configured to operate at a second frequency and/or second protocol. The device further includes a processor assembly to mix output of the first and second wireless receivers and provide audio signals representing mixed output of the first and second wireless receivers to the speaker assemblies for transducing the audio signals representing mixed output of the first and second wireless receivers.

In some embodiments the first wireless receiver is configured to operate at a first frequency and the second wireless receiver is configured to operate at a second frequency. In example implementations the first wireless receiver is configured to operate using a first protocol and the second wireless receiver is configured to operate using a second protocol. The first protocol may include Bluetooth.

In an implementation, the device includes left and right ear buds. In another implementation, the device includes left and right ear pads and is configured as a headphone. Planar magnetic speakers may be used.

In non-limiting examples the processor assembly may be configured to establish a mix output of the first and second wireless receivers according to a manufacturer-defined mix. In other examples the processor assembly can be configured to establish a mix output of the first and second wireless receivers according to a mix established by a user of the device. In some examples the processor assembly is configured to establish a mix output of the first and second wireless receivers according to an application programming interface (API). Yet again, the processor assembly can be configured to establish a mix output of the first and second wireless receivers according to a machine learning (ML) model. The processor assembly may be configured to establish a mix output of the first and second wireless receivers according to information from a computer simulation providing wireless signals to the first receiver. The information from the computer simulation may include at least one computer game scenario and/or at least one computer game state and/or computer game pixel data and/or computer game audio data. Combinations of the above mixing techniques may be used.

In another aspect, an apparatus includes at least one computer storage that is not a transitory signal and that in turn includes instructions executable by at least one processor assembly to receive first signals from a first wireless receiver on a listening device, and receive second signals from a second wireless receiver the listening device. The instructions are executable to mix the first and second signals to generate a mixed audio signal, and provide the mixed audio to first and second speakers of the listening device.

In another aspect, a method includes receiving, using a listening device, first wireless signals from a first source of audio and receiving, using the listening device, second wireless signals from a second source of audio. The method also includes mixing outputs representing he first and second wireless signals to render a mix and playing the mix on plural speakers of the listening device.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates a first example listening device;

FIG. 3 illustrates a second example listening device;

FIG. 4 illustrates electrical components of a listening device consistent with present principles;

FIG. 5 illustrates a first example transmitter/listening device architecture;

FIG. 6 illustrates a second example transmitter/listening device architecture;

FIG. 7 illustrates example logic in example flow chart format for a first mixing technique;

FIG. 8 illustrates example logic in example flow chart format for a second mixing technique;

FIG. 9 illustrates example logic in example flow chart format for a third mixing technique;

FIG. 10 illustrates example logic in example flow chart format for a fourth mixing technique;

FIG. 11 illustrates example logic in example flow chart format for a fifth mixing technique;

FIG. 12 illustrates example logic in example flow chart format for a first ML model training technique; and

FIG. 13 illustrates example logic in example flow chart format for a second ML model training technique.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor assembly may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

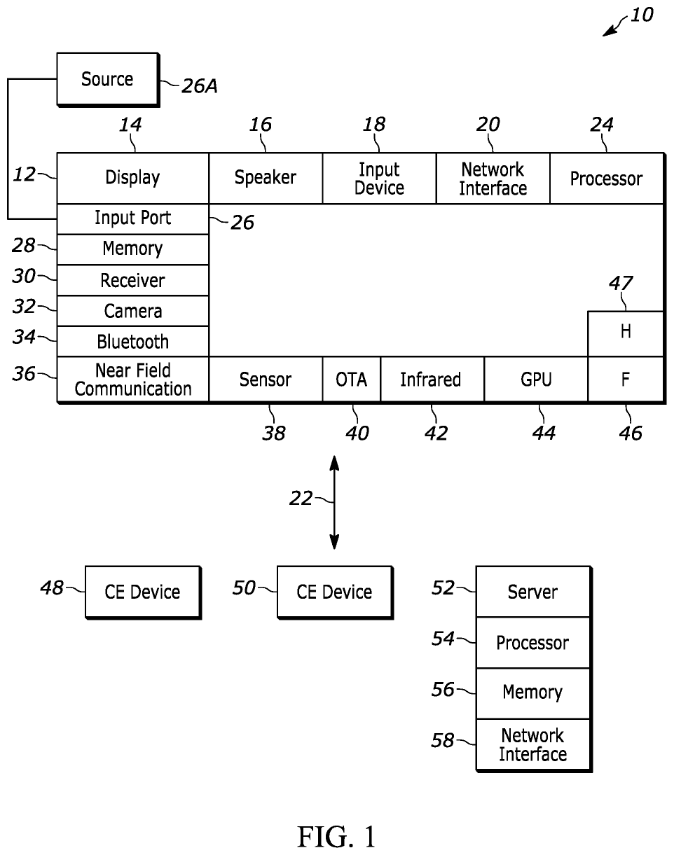

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled 5G (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. Or, a Zigbee transceiver may be used. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby. The server 52 may also be a blade server or rack server, for example.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Support vector machines (SVM) and Bayesian networks also may be considered to be examples of machine learning models. In addition to the types of networks set forth above, models herein may be implemented by classifiers. In a specific example as a large language model (LLM) such as a generative pre-trained transformer (GPTT), sometimes referred to as a “chatbot”, may be used.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

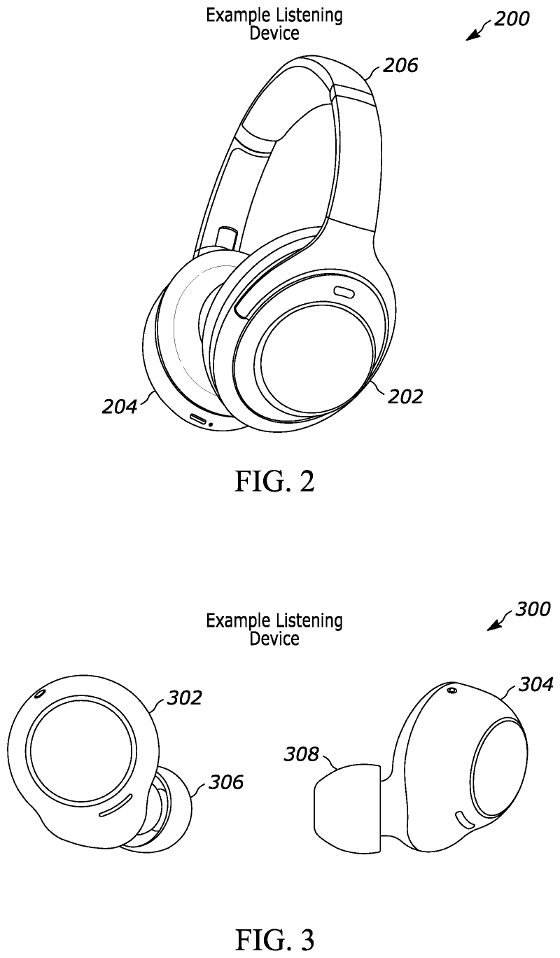

FIG. 2 illustrates a first example listening device 200 configured as an over-the-ear headset. Accordingly, the device 200 includes left and right padded ear cups 202, 204 that fit around the ears against the head of the wearer and that are connected by a curved crown support 206 that rests on top of the wearer's head. Respective speakers typically are included in each ear cup to establish a speaker assembly.

FIG. 3 illustrates a second example listening device 300 configured as ear buds. Accordingly, the device 300 includes left and right ear buds 302, 304 each with a respective ear canal engagement portion 306, 308 configured to fit comfortably within the ear canal of the wearer. Respective speakers typically are included in each ear bud to establish a speaker assembly.

The devices 200, 300 shown in FIGS. 2 and 3 may include planar magnetic speakers and as set forth further below, may be wireless in that they receive wireless signals representing audio that is transduced into sound by the speakers. The audio from the wireless link to the audio sources such as to a game console may be lossless.

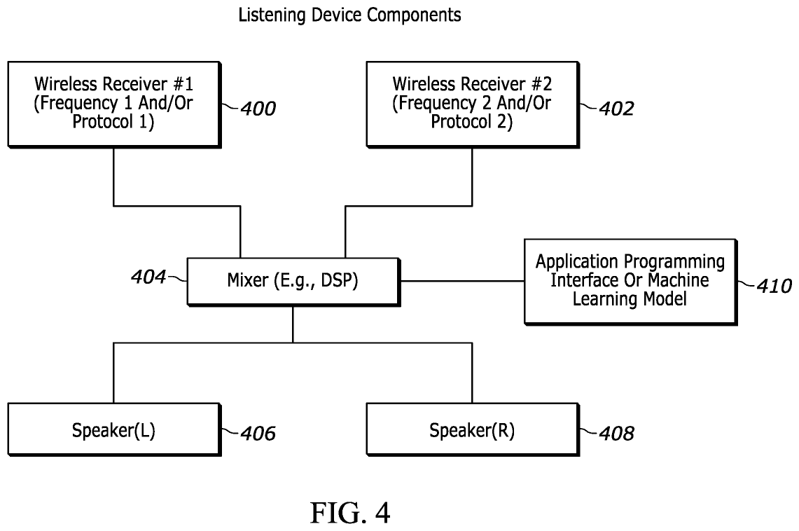

Turn now to FIG. 4 for further details of a listening device consistent with present principles, for example either of the devices 200, 300 shown in FIG. 3. A listening device includes first and second wireless receivers 400, 402. The output of each wireless receiver is sent to a mixer 404 that may be implemented by a processor assembly and in specific embodiments may be implemented by a DSP. The mixer 404 mixes the signals from the two receivers 400, 402 to output a mixed signal to left and right speakers 406, 408 (such as ear cup speakers or ear buds) for transducing of the electrical signal to acoustic to play the audio. In some embodiments discussed further herein the mixer may access an application programming interface (API) and/or a machine learning (ML) model 410 in determining how to mix the signals from the receivers 400, 402.

Mixing may include rendering an output with a greater percentage of one audio stream from the first receiver 400 compared to the percentage of the audio stream from the second receiver 402. In other words, the percentages by which each stream contributes to the final mix may be the same for both streams or different, and the mix ratios may vary as the game is played. Another way to approach understanding this technique is to consider that the volume of one stream may be made louder than the volume of the other in the final mix. Other techniques may be used for producing a mix in which the prominence of one stream is greater than that of the other stream.

The mixer 404 can amplify one or the other signal from the receivers, and which gets amplified at which time can depend on game state or otherwise be scenario-based as divulged further below.

In examples, the wireless receivers 400, 402 operate on different frequencies from each other and/or on different protocols. For example, the first receiver 400 may be configured to receive Bluetooth signals while the second receiver 402 may be configured to receive a wireless signal that is not a Bluetooth signal, such as any of the wireless protocol discussed herein. In any case, in colloquial terms the receivers 400, 402 may be different types of radios.

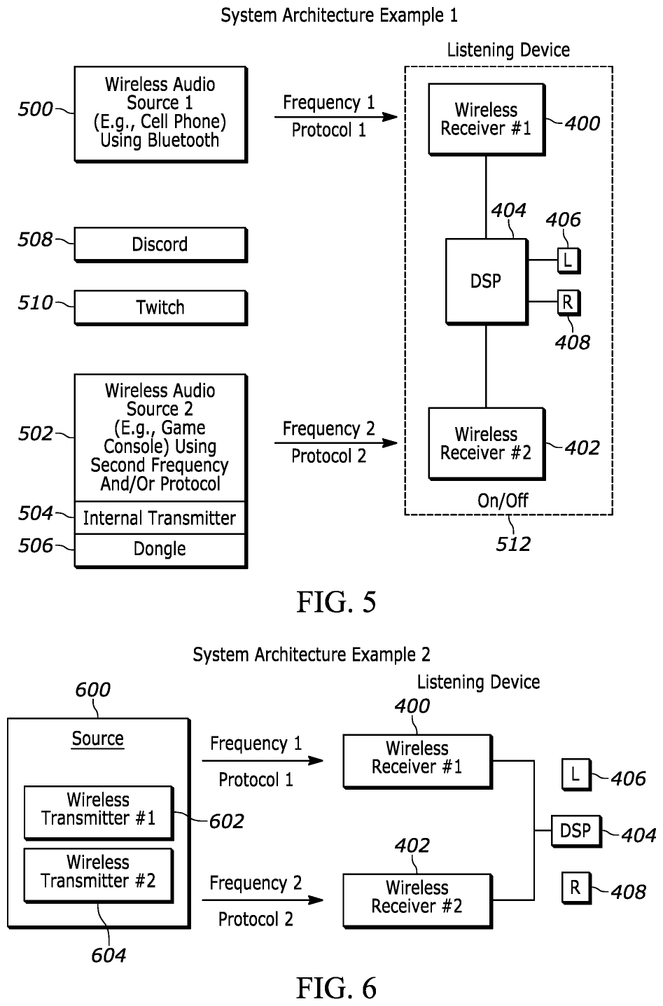

FIG. 5 illustrates a first system architecture in which a first source 500 of wireless audio signals sends wireless signal to the first receiver 400 of a listening device on a first frequency or in a first protocol, for instance Bluetooth, while a second source 502 of wireless audio signals sends wireless signal to the second receiver 402 of a listening device on a second frequency or in a second protocol, for example Wi-Fi. In an example, the first source 500 may be established by a wireless telephone while the second source 502 may be established by a computer game console that sends wireless signals via an internal wireless transmitter 504 and/or a dongle 506.

Third party applications 508, 510 are shown indicating that either one or both of the sources 500, 502 may send wireless signals representing audio from either one or both of the apps 508, 510. In the example shown, the app 508 is a Discord app and the app 510 is a Twitch app. The apps 508, 510 may connect to a computer game or platform or they may be decoupled from the platform altogether. More generally, it may now be appreciated that a wireless stream received on a wireless receiver 400, 402 may be a chat/voice stream channel, a music channel, and audio from a computer game. In this way different audio source platforms can be concurrently used while gaming, like Twitch and Discord. The first receiver 400 of a listening device herein may connect via Bluetooth to an audio source such as Discord or other third party audio, and the same listening device via the second receiver 402 can still receive game system audio (e.g., from the dongle 506) sent over an alternate wireless link over a different protocol, with the two streams being mixed at the listening device and the mix played audibly.

Also, the listening device may include an on/off toggle 512 that a user may operate to turn mixing on and off. A mix modification control 514 such as a turnable hardware r software wheel also may be provided to enable the wearer to alter the mix.

FIG. 6 illustrates a second system architecture in which a single device 600 such as a wireless telephone sends two wireless streams to a listening device. In FIG. 6, the device 600 includes first and second wireless transmitters 602, 604 that respectively communicate with the first and second wireless receivers 400, 402 on respective first and second frequencies and/or first and second protocols.

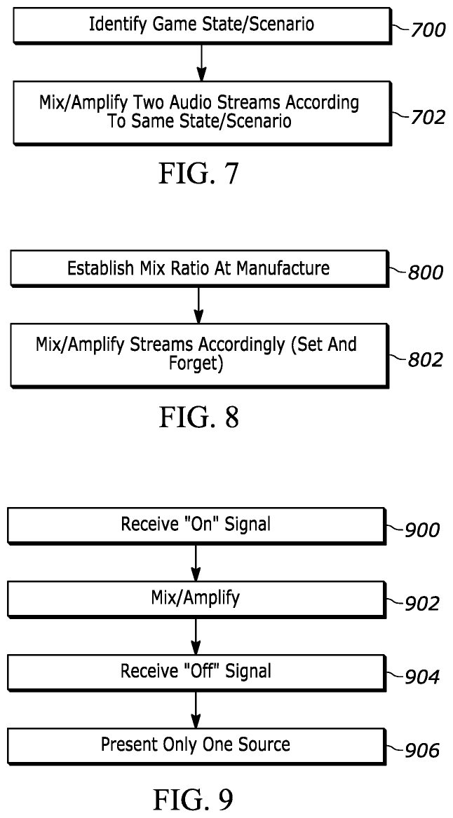

FIGS. 7-13 illustrate techniques related to mixing the audio signals received from the wireless receivers 400, 402. At block 700 in FIG. 7, a game state and/or game scenario are identified, and at block 702 the audio signals are mixed such as by individually amplifying each signal differently from the other according to the game state/scenario.

As an example, assume a first audio signal received by the first receiver 400 represents music or chat and a second audio signal received by the second receiver 402 represents game audio. If a game state is “pause”, the first audio may be made more prominent in the mix than the second audio. If the game state is “play”, the second audio may be made more prominent in the mix than the first audio. If a game scenario is “player wandering”, the first audio may be made more prominent in the mix than the second audio. If a game scenario is “fighting”, the second audio may be made more prominent in the mix than the first audio.

FIG. 8 illustrates that at block 800, a mix ratio between the signals from the two receivers 400, 402 may be established at time of manufacture and if desired not susceptible to change thereafter. At block 802 the audio signals are mixed such as by individually amplifying each signal differently from the other according to the mix ratio at block 800 in a “set and forget” mix technique.

FIG. 9 illustrates that at block 900 a “mix on” signal may be received, e.g., by manipulation of the toggle 512 shown in FIG. 5, and then signals from the receivers 400, 402 mixed at block 902 according to any of the techniques herein. Moving to block 904, should a “mix off” signal be received, at block 906 mixing is disabled and audio from only a single source/receiver (such as the receiver configured to receive wireless signals from the game console) is played.

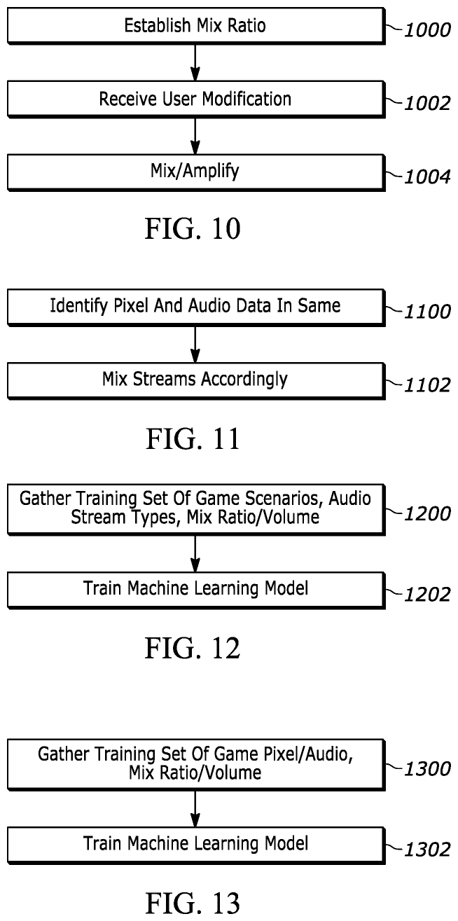

FIG. 10 illustrates that a default mix ratio may be established at block 1000 and then modified by the user of the listening device at block 1002 by, e.g., turning the wheel 514 on the listening device to alter the mix output at block 1004. For example, turning the wheel clockwise may increase the prominence of the audio signals from the first receiver 400 while turning it counterclockwise may increase the prominence of the audio signals from the second receiver 402.

FIG. 11 illustrates that at block 1100 computer game display and/or audio data may be identified and the mix of the audio from the receivers 400, 402 varied based thereon at block 1102. For example, pixel information from a computer game may be used to define how much more game audio should be made prominent over music audio, with pixel information including a high degree of motion vectors or a high degree of color differences resulting in increasing the prominence of game audio in the mix and pixel information including a low degree of motion vectors or a low degree of color differences resulting in decreasing the prominence of game audio in the mix.

FIGS. 12 and 13 illustrate training techniques for training a ML model to establish a mix ratio between the audio streams from the receivers 400, 402. At block 1200 in FIG. 12 a training set of data is altered and at block 1202 input to a ML model to train the ML model. The training set may include ground truth game scenarios (and/or game states) along with corresponding audio stream types and mix ratios or volumes.

At block 1300 in FIG. 13 a training set of data is altered and at block 1302 input to a ML model to train the ML model. The training set may include ground truth game pixel information (and/or game audio information) along with corresponding audio stream types and mix ratios or volumes.

While the particular embodiments are herein shown and described in detail, it is to be understood that the subject matter which is encompassed by the present invention is limited only by the claims.

What is claimed is:

1. A head-wearable listening device comprising:
a left speaker assembly configured to engage a left ear;
a right speaker assembly configured to engage a right ear;
a first wireless receiver configured to operate at a first frequency and/or first protocol;
a second wireless receiver configured to operate at a second frequency and/or second protocol; and
a processor assembly to mix output of the first and second wireless receivers and provide audio signals representing mixed output of the first and second wireless receivers to the speaker assemblies for transducing the audio signals representing mixed output of the first and second wireless receivers.

2. The device of claim 1, wherein the first wireless receiver is configured to operate at a first frequency and the second wireless receiver is configured to operate at a second frequency.

3. The device of claim 1, wherein the first wireless receiver is configured to operate using a first protocol and the second wireless receiver is configured to operate using a second protocol.

4. The device of claim 3, wherein the first protocol comprises Bluetooth.

5. The device of claim 1, wherein the device comprises left and right ear buds.

6. The device of claim 1, wherein the device comprises left and right ear pads and is configured as a headphone.

7. The device of claim 1, wherein the processor assembly is configured to:
establish a mix output of the first and second wireless receivers according to a manufacturer-defined mix.

8. The device of claim 1, wherein the processor assembly is configured to:
establish a mix output of the first and second wireless receivers according to a mix established by a user of the device.

9. The device of claim 1, wherein the processor assembly is configured to:
establish a mix output of the first and second wireless receivers according to an application programming interface (API).

10. The device of claim 1, wherein the processor assembly is configured to:
establish a mix output of the first and second wireless receivers according to a machine learning (ML) model.

11. The device of claim 1, wherein the processor assembly is configured to:
establish a mix output of the first and second wireless receivers according to information from a computer simulation providing wireless signals to the first receiver.

12. The device of claim 11, wherein the information from the computer simulation comprises at least one computer game scenario.

13. The device of claim 11, wherein the information from the computer simulation comprises at least one computer game state.

14. The device of claim 11, wherein the information from the computer simulation comprises at least one computer game pixel data.

15. The device of claim 11, wherein the information from the computer simulation comprises at least one computer game audio data.

16. An apparatus comprising:
at least one computer storage that is not a transitory signal and that comprises instructions executable by at least one processor assembly to:
receive first signals from a first wireless receiver on a listening device;
receive second signals from a second wireless receiver the listening device;
mix the first and second signals to generate a mixed audio signal; and
provide the mixed audio to first and second speakers of the listening device.

17. The apparatus of claim 16, wherein the first wireless receiver is configured to operate at a first frequency and the second wireless receiver is configured to operate at a second frequency.

18. The apparatus of claim 16, wherein the first wireless receiver is configured to operate using a first protocol and the second wireless receiver is configured to operate using a second protocol.

19. The apparatus of claim 16, wherein the device and the at least one processor are on the listening device.

20. A method comprising:
receiving, using a listening device, first wireless signals from a first source of audio;
receiving, using the listening device, second wireless signals from a second source of audio;
mixing outputs representing he first and second wireless signals to render a mix; and
playing the mix on plural speakers of the listening device.
